(19) United States
(12) Patent Application Publication
(10) Pub. No.: US 2019/0138914 A1
(43) Pub. Date: May 9, 2019

(54) AUTONOMOUS BOT PERSONALITY GENERATION AND RELATIONSHIP MANAGEMENT

(71) Applicant: Botanic Technologies, Inc., Emeryville, CA (US)

(72) Inventor: Mark Stephen Meadows, Emeryville, CA (US)

(21) Appl. No.: 16/014,976

(22) Filed: Jun. 21, 2018

Related U.S. Application Data
(60) Provisional application No. 62/524,435, filed on Jun. 23, 2017.

(51) Int. Cl. G06N 5/02; G06N 3/00

(52) U.S. Cl. CPC G06N 5/02; H04L 51/02; G06N 3/006

(57) ABSTRACT

Certain aspects of the technology disclosed involve systems and methods for a bot ecosystem having a social network layer and a knowledgebase layer. Bots can be generated having attribute data that define a personality of the bot. Tokens can be mined by bots via contribution to the knowledge base and interacting with other bots. Relationships among bots are managed according to preconfigured settings. Bots can be influenced and trained by updating attribute data based on interaction information.

### CROSS-REFERENCE TO RELATED APPLICATION(S)

The present application claims the benefit of U.S. Provisional Patent Application No. 62/524,435, entitled “AUTONOMOUS BOT PERSONALITY GENERATION AND RELATIONSHIP MANAGEMENT,” and filed Jun. 23, 2017, which is incorporated herein in its entirety.

The present application is related to avatar management, and more specifically to autonomous avatar personality generation and relationship management.

### BACKGROUND

An avatar is a virtual representation of an individual within a virtual environment. Avatars often include physical characteristics, statistical attributes, inventories, social relations, emotional representations, and weblogs (blogs) or other recorded historical data. Avatars may be human in appearance, but are not limited to any appearance constraints. Avatars may be personifications of a real world individual, such as a Player Character (PC) within a Massively Multiplayer Online Game (MMOG), or may be an artificial personality, such as a Non-Player Character (NPC). Additional artificial personality type avatars include personal assistants, guides, educators, answering servers and information providers. Additionally, some avatars may have the ability to be automated some of the time, and controlled by a human at other times. Such Quasi-Player Characters (QPCs) may perform mundane tasks automatically, but more expensive human agents take over in cases of complex problems.

Avatars, however, exist in virtual worlds that embrace anonymity. An avatar may appear any way the author of the avatar, or end user, desires. Moreover the name, appearance, and statistics of an avatar may often be changed on a whim. An end user may have several avatars for any virtual environment, and connecting an avatar to its end user is difficult at best.

The number of active subscribers to MMOGs is at least 10 million people. Each person pays $15 and up a month to play these games, and maybe an additional 7 million people login occasionally. At least 1.5 million people subscribe to virtual worlds. Moreover, participants in web communities number in the multiple tens of millions. Every day, these participants engage in financial transactions. Additionally, access to certain information, subsets of the virtual world, or services may be restricted to certain participants only. Such activities produce a large risk for the parties involved, much of the risk stemming from identity ambiguities.

Currently, when a party wishes to provide sensitive information, transfer goods or allow access to an avatar embodied end user, local reputation of the avatar, if available, is often the only assurances the party has, since there is currently no way to ascertain end user reputation beyond the limited reputation of each individual avatar's local reputation. End users may improperly use received information, misrepresent themselves to gain access, or breach contract since there is usually no repercussions to the end user because, with a simple change in identity, the wrong deed is no longer traceable to the end user.

### SUMMARY

Certain aspects of the technology disclosed relate to systems and methods for autonomous personality generation and relationship management. The personality is an orchestration of data types and includes at-tributes that allow the coordination with other personalities, self-management and improvement. Data from past interactions are used to improve future relationships and data sources that improve the system—commonly people—may be remunerated. Relationships are managed according to preconfigured settings, however these, as well as other data types in the system, may be influenced and trained.

Embodiments of the innovation include an ecosystem of bots having particular personality attributes that are incentivized to contribute to a knowledge bank. Contributions to the knowledge bank are logged via a first blockchain. In response to providing a contribution, a bot receives a token which is logged via the first blockchain and/or a second blockchain.

Embodiments of the innovation includes managing relationships among bots within an ecosystem. Relationships corresponding to one or more bots in an ecosystem is monitored and maintained by a social graph. Each bot can be represented as a node on the social graph and closeness among bots can be measured and reevaluated based on interactions between the bots. The bots can be visually represented as a character, that may be moved, stretched, or otherwise dynamically represented and edited by keyboard, gesture, voice, gaze, thought or a combination of the above. Input and output fields, as well as core processing associations (such as learning and training methods) may be included for text, image, animation, sounds or other data including turing-complete programs. Each end node, or leaf, of the dialogue structure may be expanded to facilitate additional input and represent its own use flow or non-formalized data structure. Textual, verbal, and visual interactions exchanged between nodes are monitored and analyzed to determine a closeness between nodes on the social graph.

Embodiments of the innovation include methods to increase security in communications and data storage among bots and by an ecosystem of bots. Communication between a user and a bot is end-to-end encrypted. The bot includes a key configured to decrypt a portion of a received message. A portion of the message can remain in an encrypted state. Decryption can terminate upon identification of a termination key in the message. The message including a decrypted portion and an encrypted portion can be stored by the bot. The bot can include identifying information in the message data and use the message data to update a knowledge base in a bot ecosystem.

Embodiments of the disclosed technique include using reputation information from a centralized identity provider to authenticate an avatar. An authentication system is useful in conjunction with security and identification within a bot ecosystem. Authenticated bots can be permitted to perform certain functions within a bot ecosystem such as, for example, update data in a knowledge base, release tokens to another bot, receive tokens, engage with other bots, edit code having a particular priority level, or any combination thereof. Various levels of authentication are contemplated. Subsequent levels of authentication can allow a bot to perform additional tasks.

### BRIEF DESCRIPTION OF THE DRAWINGS

FIG. 1 illustrates bots authorized to modify a knowledge base system, according to an embodiment.

FIG. 2 illustrates bots mining tokens by modifying a knowledge base system, according to an embodiment.

FIG. 3 illustrates a customer interface system for authoring one or more attributes of a bot, according to an embodiment.

FIG. 4 illustrate examples of bot attributes, according to an embodiment.

FIG. 5 illustrates a secure connection between one or more bots and one or more users, according to an embodiment.

FIG. 6 illustrates examples of accounts available for users, according to an embodiment.

FIG. 7 is a diagrammatic representation of a machine in the example form of a computer system within which a set of instructions, for causing the machine to perform any one or more of the methodologies or modules discussed herein, can be executed.

The figures depict various embodiments of this disclosure for purposes of illustration only. One skilled in the art can readily recognize from the following discussion that alternative embodiments of the structures and methods illustrated herein can be employed without departing from the principles of the invention described herein.

### DETAILED DESCRIPTION

Certain aspects of the technology disclosed involve systems and methods for autonomous personality generation and relationship management. An avatar personality is an orchestration of data types and includes attributes that allow coordination with other personalities, self-management, and improvement. Data from past interactions are used to improve future relationships and data sources that improve the system. A user of an avatar may be remunerated for avatar interactions. Relationships are managed according to preconfigured settings, however these, as well as other data types in the system, may be influenced and trained.

Due to the fragmented multitudes of virtual worlds, a cross-platform system can improve avatar management and authentication. By removing an authentication system from any singular virtual world, and enabling a cross-platform system, reputation and identity information may be more accurately compiled. Also, such a system enables secure communications between individuals that are inhibiting separate virtual worlds by verifying identity of the individuals within each virtual environment. Systems for authenticating an avatar's end users' identity and supplying reputation information in this manner do not currently exist.

Additionally, due to the frequency of financial transactions, and the regularity of access inquiries, such authentications are preferably performed rapidly, with a minimal interference to the end user and transacting party. As such, it is desirable to have a system for authenticating an avatar's end users' identity and supplying reputation information that is integrated into the virtual environment for rapid and efficient authentication.

### Terminology

The term “bot” is used to include a range of automatically-guided and autonomous or semi-autonomous systems including chatbots, assistants, bots and robots. These are all contained under the term “bot” and are interchangeable, unless otherwise noted, in this description. The core differences are in terms of input/output modalities: a chatbot generally does not have audio or visual components, an assistant contains the capabilities of a chatbot, but does not generally have visual components, and bot contains the capabilities of the other two but does not generally have a physical presence, whereas a robot is capable of all the modalities chatbots, assistants, and bots have while also having the additional physical presence.

The term “conversation” is intended to include a range of human interactions. In most cases conversation includes reading, writing, speaking and listening to words, but not exclusively (as in the case of sign language, or simply holding up a card with writing on it, or a word may be heard without any visible source). “Conversation” also includes a broad range of multi-modal indicators such as visual cues (e.g. body language, gesture, posture, cues, eye contact), auditory cues (e.g. intonation, prosody, tonality,), and physical cues (e.g. personal space, physical contact, etc). Conversation may also include null data, cues, or information such as pauses, a lack of response, a lack of expression, a lack of tone, or other void data.

The term “autonomous” indicates that a stimulus/response or input/output result is triggered without human intervention, or that a series of such causes and effects are chained together, or even simultaneously orchestrated, such that the system gives the impression of having made a decision. Functionality of the autonomous system may also be applicable to human-driven systems, provided the system was influenced by the human after being “clutched” or “turked” (see Input Methods). Semi-autonomous is a term used to indicate some human influence of a specific portion of data, iteration, input or output.

The term “personality” is a collection of textual, auditory, visual, and social elements taken as an orchestrated whole.

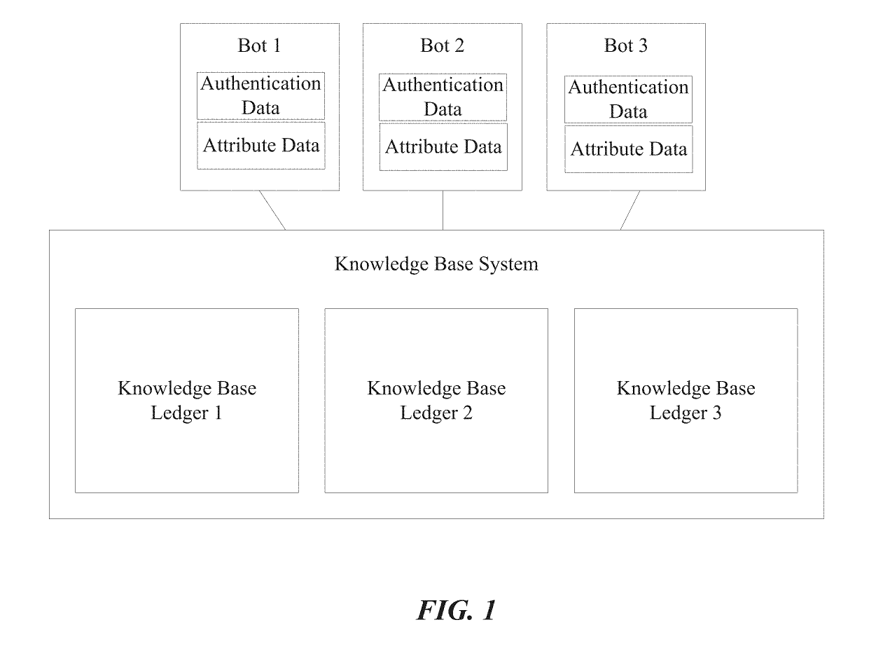

FIG. 1 illustrates bots authorized to modify a knowledge base system, according to an embodiment. An ecosystem of bots having particular personality attributes that are incentivized to contribute to a knowledge bank. The ecosystem can include a social network overlay and a knowledge base overlay which overlap with one another. Relationship data among bots can be retrieved from the social network overlay and the knowledge base overlay. Contributions to the knowledge bank are logged via a first blockchain. In response to providing a contribution, a bot receives a token which is logged via the first blockchain and/or a second blockchain.

Embodiments of the innovation include managing relationships among bots within an ecosystem. Relationships corresponding to one or more bots in an ecosystem is monitored and maintained by a social graph. Each bot can be represented as a node on the social graph and closeness among bots can be measured and reevaluated based on interactions between the bots. The bots can be visually represented as a character, that may be moved, stretched, or otherwise dynamically represented and edited by keyboard, gesture, voice, gaze, thought or a combination of the above. Input and output fields, as well as core processing associations (such as learning and training methods) may be included for text, image, animation, sounds or other data including turing-complete programs. Each end node, or leaf, of the dialogue structure may be expanded to facilitate additional input and represent its own use flow or non-formalized data structure. Textual, verbal, and visual interactions exchanged between nodes are monitored and analyzed to determine a closeness between nodes on the social graph.

A bot has a personality which is an orchestration of data types and includes at-tributes that allow the coordination with other personalities, self-management and improvement. Data from past interactions are used to improve future relationships and data sources that improve the system. Relationships are managed according to preconfigured settings, however these, as well as other data types in the system, may be influenced and trained.

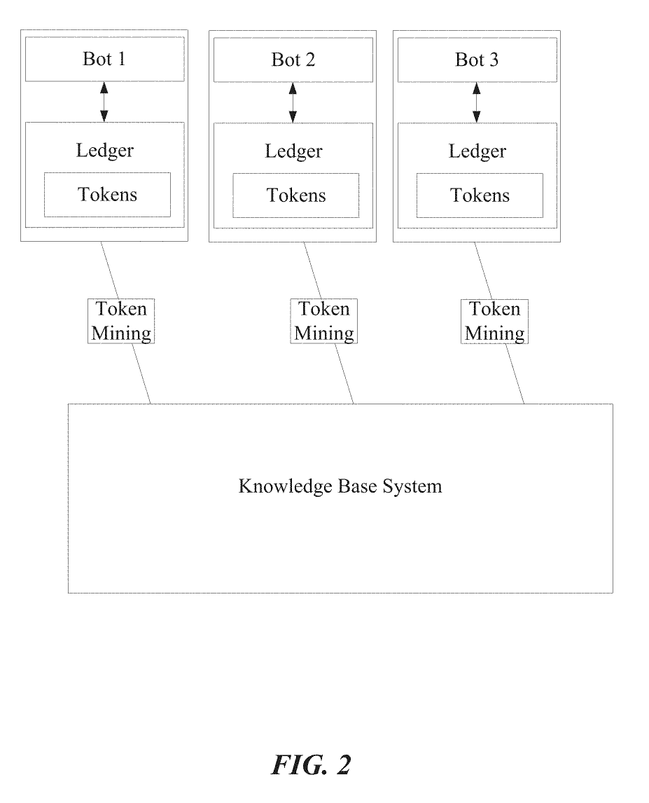

FIG. 2 illustrates bots mining tokens by modifying a knowledge base system, according to an embodiment. Tokens can be mined by contributing to the knowledge base. A token value for a contribution can be determined based on a correspondence between a subject matter of a contribution and a priority level assigned to a bot for the subject matter. For instance, a bot designated as an expert in astrophysics contributing to an astrophysics dataset is determined to have a higher token value than a bot lacking expertise contributing to the astrophysics dataset.

A blockchain ledger is maintained for tokens in the ecosystem. Tokens can be mined by bots, for example, in the knowledge base layer. Tokens can be exchanged among bots, for example, in the social network layer.

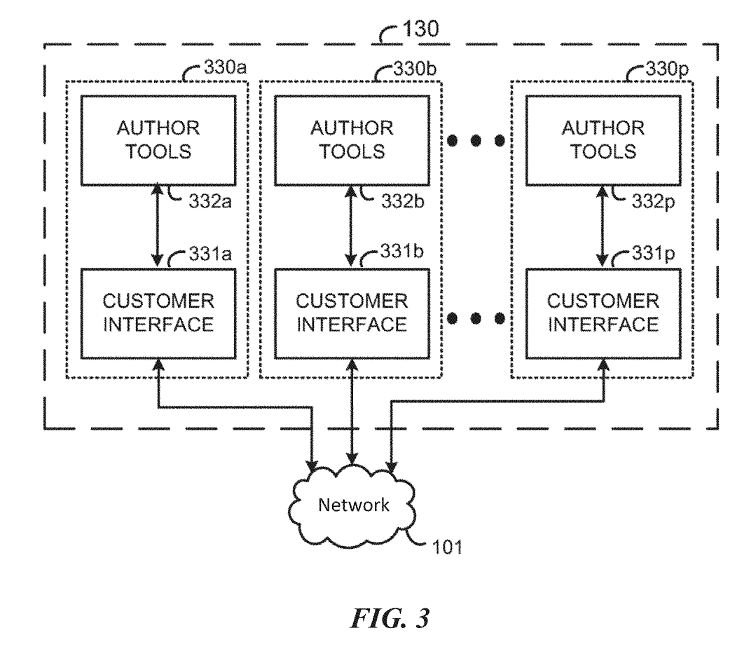

FIG. 3 illustrates a authoring interface system for authoring one or more attributes of a bot, according to an embodiment.

The authoring interface system can enable a user to select or modify one or more bot attributes. These are tools can enable a person to define a conversation style, character appearance, and mannerisms.

Conversation use flow authoring tool. This is a method of inputting, structuring, editing and organizing data relationships relevant to the conversation of two or more bots. The conversation is expressed as a flowchart and/or a collection of text, sounds, images, time-based elements (e.g. questions/answers, causes/effects, etc), functional activities, and social relationships. The entities may be multiple people and/or multiple bots. The representation of data is most commonly a visual chart, that may be moved, stretched, or otherwise dynamically represented and edited by keyboard, gesture, voice, gaze, thought or a combination of the above. Input and output fields, as well as core processing associations (such as learning and training methods) may be included for text, image, animation, sounds or other data including turing-complete programs. Each end node, or leaf, of the dialogue structure may be expanded to facilitate additional input and represent its own use flow or non-formalized data structure.

Character authoring tool. This is an method of inputting, structuring, editing and organizing data relationships relevant to the character of one or more bots. The character is expressed as a flowchart and/or a collection of text, sounds, images, time-based elements (e.g. animations, transformation, deformations, etc), functional activities, and social relationships. The entities may be multiple people and/or multiple bots. The representation of data is most commonly a visual chart, that may be moved, stretched, or otherwise dynamically represented and edited by keyboard, gesture, voice, gaze, thought or a combination of the above. Input and output fields, as well as core processing associations (such as learning and training methods) may be included for text, image, animation, sounds or other data including turing-complete programs. Each end node, or leaf, of the dialogue structure may be expanded to facilitate additional input and represent its own use flow or non-formalized data structure. This character is a dynamic thing in that it may change to other variables of the end-user state data that are directly mapped (lexical values would map to the user's words, audio values would map to the user's voice, appearance would map to the user's face, etc).

Animation authoring tool. This is an method of inputting, structuring, editing and organizing data relationships relevant to the animation of one or more entities. The animation is expressed as a flowchart and/or a collection of text, sounds, images, time-based elements (e.g. movements, transformations, deformations, etc), functional activities, and social relationships. The entities may be multiple bots. The representation of data is most commonly a visual representation of a character, that may be moved, stretched, or otherwise dynamically represented and edited by keyboard, gesture, voice, gaze, thought or a combination of the above. Input and output fields, as well as core processing associations (such as learning and training methods) may be included for text, image, animation, sounds or other data including turing-complete programs. Each end node, or leaf, of the dialogue structure may be expanded to facilitate additional input and represent its own use flow or non-formalized data structure.

Editing. Training and tuning of words, sounds, appearance, and social interaction. These are tools that allow people, accompanied by a bot, to improve existing data sets that compose a bot's words, sounds, images and social dynamics.

Lexical editing & training tool. Bot learns local/personal words. This is a method of editing and input in which the bot interacts with one or more users and learns how the user talks, at a detailed level, via natural dialogue, lexical, grammatical, vocabulary, context and other lexical aspects of conversation. This training may be done at a desk, via a keyboard, via a telephone, wearable device, in person, in virtual or augmented environments, while driving, using a motion capture device, a brain-machine interface, or other circumstances. The resulting output may be a data set of structured or unstructured data, including a flowchart or other tool for later editing.

Audio editing & training tool. Bot learns local/personal sounds. This is a method of editing and input in which the bot interacts with one or more users and learns how to associate words and/or images to tone, accent, slang, intonation, inflection, context and other auditory aspects of conversation. This training may be done at a desk, via a keyboard, via a telephone, wearable device, in person, in virtual or augmented environments, while driving, using a motion capture device, a brain-machine interface, or other circumstances. The resulting output may be a data set of structured or unstructured data, including a flowchart or other tool for later editing.

Visual editing & training tool. Bot learns local/personal images. This is a method of editing and input in which the bot interacts with one or more users and learns how to associate words and/or sounds to gestures, timing, amplitude, speed, direction, context and other visual aspects of conversation. This training may be done at a desk, via a keyboard, via a telephone, wearable device, in person, in virtual or augmented environments, while driving, using a motion capture device, a brain-machine interface, or other circumstances. The resulting output may be a data set of structured or unstructured data, including a flowchart or other tool for later editing.

Social editing & training tool. Bot learns local/personal socialization. This is a method of editing and input in which the bot interacts with one or more users and learns how to associate words and/or sounds and/or images to social cues that are awaited, directed, unique, accidental, planned, unplanned, repeated, interrupted and other cues such as proximity, timing, visual, auditory, and lexical aspects of conversation. This training may be done at a desk, via a keyboard, via a telephone, wearable device, in person, in virtual or augmented environments, while driving, using a motion capture device, a brain-machine interface, or other circumstances. The resulting output may be a data set of structured or unstructured data, including a flowchart or other tool for later editing.

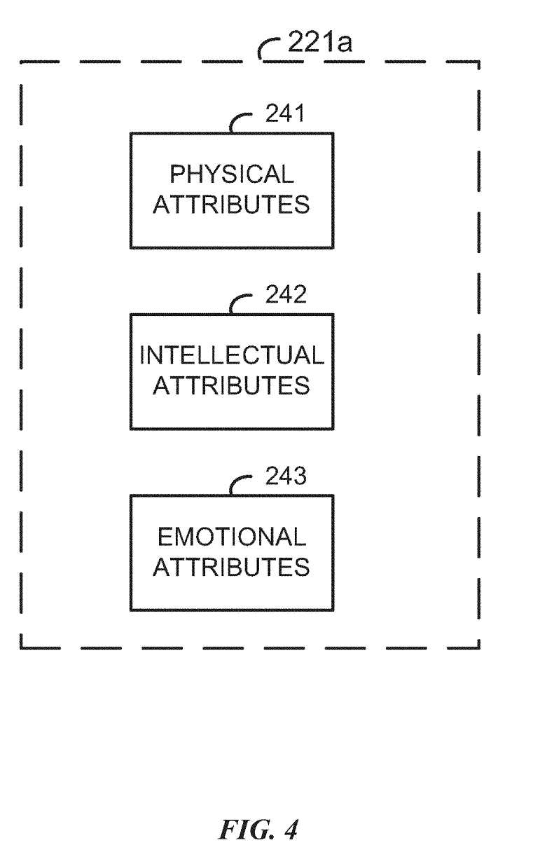

FIG. 4 illustrate examples of bot attributes, according to an embodiment. Bot attributes can be adjusted over time. For instance, bot attributes can be manually adjusted or trained based on circumstance and context of one or more interactions.

Prepared for social interaction. User & System management methods. These are tools that allow a bot to be automatically fine-tuned for conversations, characters, and interactions.

Clutching/turking. Methods for removing autonomous behavior to control an individual bot with keyboard and/or voice and/or camera input.

Identifying user traits. Method for identifying and measuring end-user traits, updating user state, and then reflecting them to the end user at appropriate moments.

Identifying background images. Scanning of the environment and recognizing images behind conversant's image

Identifying background sounds. Scanning of the environment and recognizing sounds behind conversant's voice

Crowd Conversations. Conversation management methods for multiple people & bots.

Multi-bot conversation input with multi-party user input (multiple bots/multiple people). Single-bot conversation input with multi-party user input (single bot/multiple people). Multi-bot conversation input with single-party user input (multiple bots/single person)

User State data management methods. These are means of managing user state data to a more refined level.

Track vital signs. This is a method for measuring vital stats (heartrate, breathing, etc) without a hardware peripheral

Assess genomic data. This is a method for determine the end-user health based on facial appearance and voice wave data mapped to genomic data.

Assess illness. Delta of user interaction over delta of symptom evidence such as photo, sound, trembling, peripherals, semantic, etc.

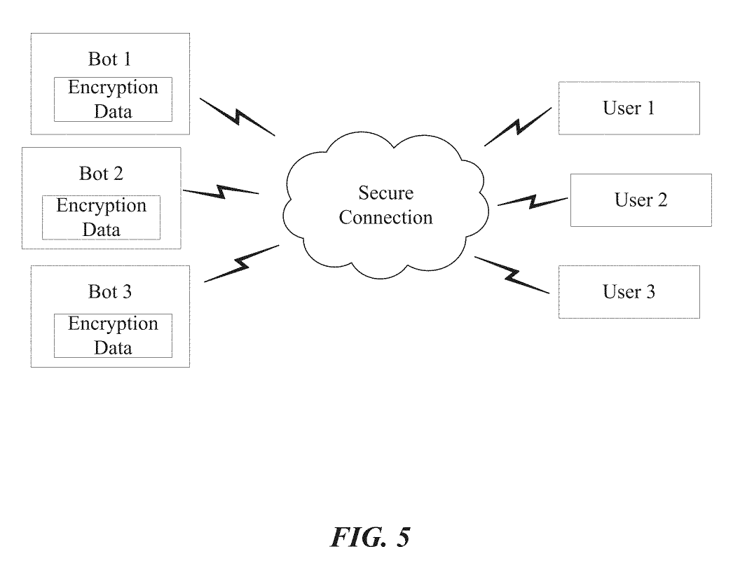

FIG. 5 illustrates a secure connection between one or more bots and one or more users, according to an embodiment. Communication between a user and a bot is end-to-end encrypted. The bot includes a key configured to decrypt a portion of a received message. The received message can be encrypted one or more times (i.e. cascade encrypted). The bot can decrypt the received message by applying the same algorithm multiple time or by applying a combination of algorithms one or more times (e.g., dual key or any combination of keys). AES symmetric block cipher, decentralized public key infrastructure via SHA-256 hashes can be used.

A portion of the message can remain in an encrypted state. Decryption can terminate upon identification of a termination code in the message. The message including a decrypted portion and an encrypted portion can be stored by the bot. The bot can include identifying information in the message data and use the message data to update a knowledge base in a bot ecosystem.

Identity management is implemented to increase security. User passwords and passphrases can be coordinated with user face, voice, bot state data, behavioral data, mobile exhaust data, or any combination thereof.

Stenographic encryption can be used to insert a furtive object into one or more datasets. For example, a furtive object can be inserted into a message received from a user which is inserted into the knowledge base. The furtive object can be used to monitor data flow and transport through the ecosystem including data origination.

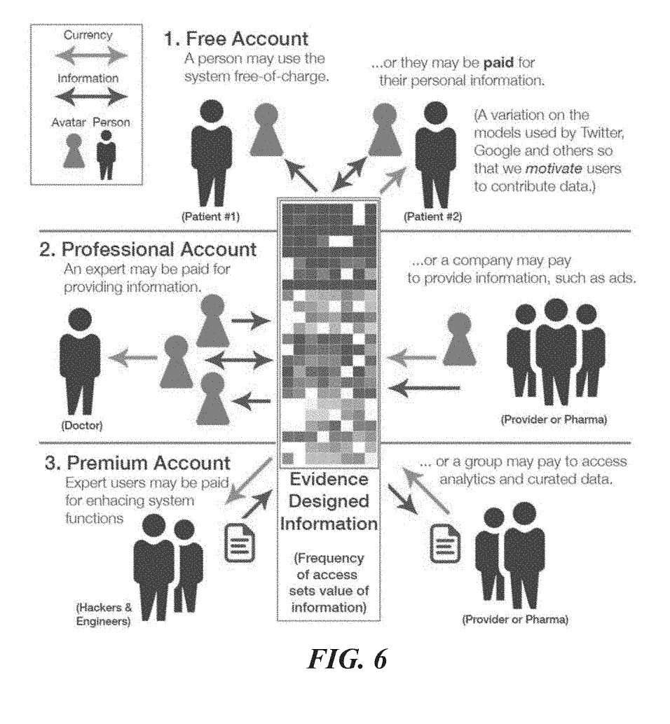

FIG. 6 illustrates examples of accounts available for users, according to an embodiment. Users can be validated as an expert in one or more subjects. The validation process can include obtaining a certification from the user in a subject, providing a test to a user regarding a subject, providing data related to a subject, having a relationship with another bot or user certified in a subject, or a combination thereof. A certified expert in a subject can have a higher priority level on a subject than a non-certified user. The higher priority level can provide a higher level of management over data related to the subject including editing authorization, rejecting edits of lower priority level users, restricting access of lower priority user to a subject, blocking lower priority users from a subject, or any combination thereof.

A priority level to a subject can also be used in determining remuneration for activities performed related to the subject. For example, a bot certified as an expert in a subject can receive a greater remuneration for a contribution to the subject than a non-certified bot for the same contribution.

Bots as shapers of social groups. These programs may be designed to introduce upbeat people into less positive groups, link exercisers to complementary sedentary people, and introduce citizens with high levels of local engagement to neighbors who are less engaged.

Bots as managers and HR departments. By analyzing dialogue trends in social networks bots may decide when to conduct transactions, invite and initiate business relations, and form new business entities. These bots may also initiate, negotiate, and complete transactions. By extension, this allows the personality of the organization—its culture—to also be a design element.

Social coordination of group moods in response to particular emergencies, benefits, or states of group existence/“As a result, we may see greater spikes in global emotion that could generate increased volatility in everything from political systems to financial markets.”

Embodiments of the present innovation can be implemented on various platforms. For example, AR+VR+Home+Car+Phone+wearable+other networked terminal can be used. Users can utilize one or more platforms to access a bot that facilitates social interaction—telephone answering machine, entertainment, choose your own bot, playful interactions, learning. For example, everyone on a video calling platform can have their own bot and/or a shared bot. Video calling users can have a bot representing themselves that acts as an answering machine—and interact with their own bots. Single function bots for jokes, service-oriented, personality is linked to use flow, entertaining. Mirroring of body language, phrases—able to pick up on learning styles. Adaptive personality. Animation methods, voice methods. Personality is defined by/conveyance of personality—fashion, social interaction, introvert-extrovert (MB), etc. trust: “a comfortable relationship with the unknown” watching them make decisions, how they compare to us. Methods from acting, theater, psychology, movies, music.

Relationship management is mapped to others' use. Patterns of behavior are detected and a percentage probability of behavior affects the gambit.

A pattern that is broken is ‘noticed’ and a break in common behavior—or common behavior of other users—is compared to a current interaction and modifies or is accounted for, in the use flow, words, behavior, etc.

### Computer

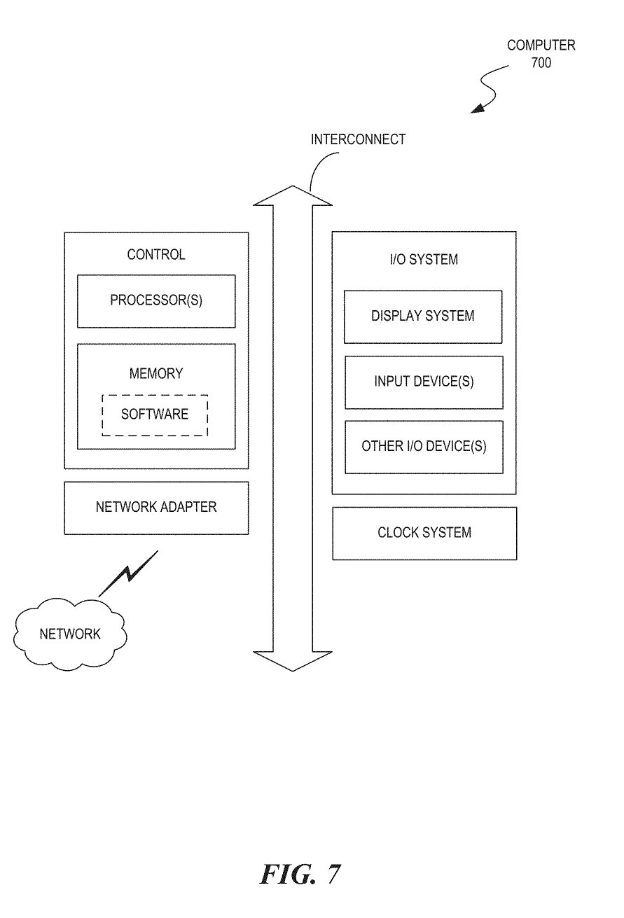

FIG. 7 is a diagrammatic representation of a machine in the example form of a computer system 700 within which a set of instructions, for causing the machine to perform any one or more of the methodologies or modules discussed herein, can be executed.

In the example of FIG. 7, the computer system 700 includes a processor, memory, non-volatile memory, and an interface device. Various common components (e.g., cache memory) are omitted for illustrative simplicity. The computer system 700 is intended to illustrate a hardware device on which any of the components described in the example of FIGS. 1-5 (and any other components described in this specification) can be implemented. The computer system 700 can be of any applicable known or convenient type. The components of the computer system 700 can be coupled together via a bus or through some other known or convenient device.

This disclosure contemplates the computer system 700 taking any suitable physical form. As example and not by way of limitation, computer system 700 can be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 700 can include one or more computer systems 700; be unitary or distributed; span multiple locations; span multiple machines; or reside in a cloud, which can include one or more cloud components in one or more networks. Where appropriate, one or more computer systems 700 can perform without substantial spatial or temporal limitation one or more steps of one or more methods described or illustrated herein. As an example and not by way of limitation, one or more computer systems 700 can perform in real time or in batch mode one or more steps of one or more methods described or illustrated herein. One or more computer systems 700 can perform at different times or at different locations one or more steps of one or more methods described or illustrated herein, where appropriate.

The processor can be, for example, a conventional microprocessor such as an Intel Pentium microprocessor or Motorola PowerPC microprocessor. One of skill in the relevant art can recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer system 700. The non-volatile storage can be local, remote, or distributed. The non-volatile memory is optional because systems can be created with all applicable data available in memory. A typical computer system can usually include at least a processor, memory, and a device (e.g., a bus) coupling the memory to the processor.

Software is typically stored in the non-volatile memory and/or the drive unit. Indeed, storing an entire large program in memory may not be possible. Nevertheless, it should be understood that for software to run, if necessary, it is moved to a computer readable location appropriate for processing, and for illustrative purposes, that location is referred to as the memory in this paper. Even when software is moved to the memory for execution, the processor can typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It can be appreciated that a modem or network interface can be considered to be part of the computer system 700. The interface can include an analog modem, ISDN modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 7 reside in the interface.

In operation, the computer system 700 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts utilized by the operating system to input and output data and to store data in the memory, including storing files on the non-volatile memory and/or drive unit.

Some portions of the detailed description can be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems can be used with programs in accordance with the teachings herein, or it can prove convenient to construct more specialized apparatus to perform the methods of some embodiments. The utilized structure for a variety of these systems can appear from the description below. In addition, the techniques are not described with reference to any particular programming language, and various embodiments can thus be implemented using a variety of programming languages.

In alternative embodiments, the machine operates as a standalone device or can be connected (e.g., networked) to other machines. In a networked deployment, the machine can operate in the capacity of a server or a client machine in a client-server network environment, or as a peer machine in a peer-to-peer (or distributed) network environment.

The machine can be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art can appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, can comprise a transformation, such as a physical transformation. With particular types of memory devices, such a physical transformation can comprise a physical transformation of an article to a different state or thing. For example, but without limitation, for some types of memory devices, a change in state can involve an accumulation and storage of charge or a release of stored charge. Likewise, in other memory devices, a change of state can comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device can comprise a transformation, such as a physical transformation. Rather, the foregoing is intended as illustrative examples.

A storage medium typically can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

### Remarks

The foregoing description of various embodiments of the claimed subject matter has been provided for the purposes of illustration and description. It is not intended to be exhaustive or to limit the claimed subject matter to the precise forms disclosed. Many modifications and variations can be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art can appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods can vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it cannot have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

What is claimed is:

1. A bot ecosystem, comprising:
a social network layer configured to facilitate communication among a plurality of bots, wherein the social network layer monitors relationships among the plurality of bots; and
a knowledge base layer configured to receive information from authorized bots among the plurality of bots, wherein one or more privileges in knowledge base management corresponds to a level of authorization assigned to a bot.

2. The bot ecosystem of claim 1, further comprising:
a blockchain layer monitoring contributions of the authorized bots in the knowledge base layer; and
in response to detecting a contributions, determining a token value corresponding to the contribution.

3. The bot ecosystem of claim 1, wherein the social network layer monitors relationships among the plurality of bots by updating a social graph including nodes representing the plurality of bots and closeness factors calculated based on interactions among the plurality of bots.
